(19) United States
(12) Patent Application Publication
(10) Pub. No.: US 2003/0161065 A1
(43) Pub. Date: Aug. 28, 2003

(54) Method and apparatus for controlling the actuator of the head-positioning system provided in a disk drive

(76) Inventor: Masahide Yatsu, Akishima-shi (JP)

Correspondence Address: PILLSBURY WINTHROP, LLP, P.O. BOX 10500, MCLEAN, VA, 22102, US

(21) Appl. No.: 10/354,166

(22) Filed: Jan. 30, 2003

(30) Foreign Application Priority Data
Jan. 30, 2002 (JP) 2002-022313

(51) Int. Cl. G11B 21/02

(52) U.S. Cl. 360/75

(57) ABSTRACT

Disclosed herein is a disk drive that includes a head, an actuator holding the head, and a control section for driving and controlling the actuator. The control section includes a control system and a head-positioning system. The control system performs multi-rate control to adjust the velocity of the actuator while the head is being loaded and unloaded. The control system also suppresses a gain corresponding to a specific frequency component of the mechanical resonance of the actuator, by performing the multi-rate control.

### CROSS-REFERENCE TO RELATED APPLICATIONS

This application is based upon and claims the benefit of priority from the prior Japanese Patent Application No. 2002-022313, filed Jan. 30, 2002, the entire contents of which are incorporated herein by reference.

### BACKGROUND OF THE INVENTION

1. Field of the Invention

The present invention relates generally to disk drives, and more particularly to an apparatus and method for controlling the actuator of a head-positioning system provided in a disk drive.

2. Description of the Related Art

Disk drives, a representative example of which is a hard disk drive, comprise a loading/unloading mechanism, an actuator, a head supported on the actuator, a voice coil motor for rotating the actuator, a ramp member, and a head-positioning system. The loading/unloading mechanism (also known as “ramp loading mechanism”) is designed to move the head to a position above disks and retract the head from that position.

The loading/unloading mechanism retracts the head to the rampp member (also known as “parking ramp”) provided outside the disk, when it is unnecessary to write data on, or read data from, the disk. The heads can be therefore parked at the ramp member while the power switch of the disk drive remains off or while the disk remains stopped.

While the disk is rotating, the loading/unloading mechanism moves the head from the parking area of the ramp member to a position above the disks, in response to a command from the host system that is provided outside the disk drive. This motion of the heads is called “loading.” When the loading is completed, the head is positioned and starts reading data from the disk or writing data on the disk. The head-positioning system controls the actuator, which moves the head to a desired position (i.e., the track to be accessed). When the head finishes reading data from, or writing data on, the disk, the loading/unloading mechanism performs unloading, retracting the head to the ramp member.

Thus retracted, the head would not contact or collide with the disks when the power switch is turned off or when the disk stops rotating. As a result, the head and the disk are protected against damages.

The head-positioning system has a micro-controller (CPU) as main component. The CPU receives servo data that the head has read from the disk. In accordance with the servo data, the CPU performs a servo control to move the head to desired positions over the disk.

The CPU cannot obtain the servo data while the head is being loaded or unloaded. To move the head to the desired position while the head is being loaded or unloaded, the CPU needs to control the motion of the head. More specifically, the CPU must control the velocity at which the actuator holding the head is moved over the disk. This control of velocity is known as “velocity feedback control.”

A velocity feedback control is disclosed in, for example, Jpn. Pat. Appln. KOKAI Publication No. 11-96708. In this control, the back electromotive force (EMF) of the voice coil motor (VCM) driving the actuator is detected, determining the velocity at which the head (or the actuator) are moving. The velocity thus determined is used to achieve velocity feedback control.

In short, the velocity the head (or the actuator) moving is determined from the back EMF of the VCM and utilized to control the motion of the head (or the actuator).

In disk drives, the head-positioning system that controls the velocity of the head is a so-called “sampled data control system.” This system comprises a controller (equivalent to a CPU) that intermittently controls a plant that continuously operates for a long time. The plant may be the VCM that drives the actuator.

The controller used in the sampled data control system samples the outputs of the plant at regular intervals (i.e., sampling intervals). Every time the controller samples an output of the plant, it finds a control value (i.e., the current for driving the VCM).

During the loading and the unloading, the back EMF of the VCM is sampled at the regular intervals (i.e., sampling intervals). The back EMF sampled at each time, which is an analog value, is converted to a digital value. The digital value is supplied to the CPU. From the digital value the CPU calculates the velocity of the head (or the actuator) that is moving. Thus, the CPU accomplishes the control (velocity control). The CPU finds a difference between the velocity calculated and the actual velocity of the head (or actuator). The CPU then calculates a control value that will eliminate the velocity difference. The CPU supplies the control value to the driver that drives the VCM. Thus, the velocity control system used in the disk drive is a discrete-time control system that finds a control value every time the back EMF of the VCM is sampled.

The actuator may contact the ramp member and slide thereon as it is moved during the loading and the unloading. It has been confirmed that the actuator undergoes mechanical resonation, making a noise, when it contact the rampp member. The noise due to the mechanical resonation is attributable to the waveform of the drive current supplied to the VCM. It has been also found that the noise results from a resonance-frequency component of about several kilohertz.

In recent years, disk drives have come to be used not only as not external storage devices to personal computers, but also as storage devices in AV apparatuses such as digital television receivers. In view of this, some measures should be taken to suppress noises in the disk drives.

The conventional velocity control system designed to control the velocity of the actuator during the loading and unloading in a disk drive changes the control at the same intervals as the back EMF of the VCM is sampled. (The control value changed is supplied to the CPU.) The actuator inevitably makes noise at a resonance frequency higher than Nyquist frequency (i.e., the highest frequency the control system can control) unless the above-mentioned sampling intervals are appropriate. The conventional velocity control system cannot adequately suppress the noise resulting from the mechanical resonance of the actuator.

### BRIEF SUMMARY OF THE INVENTION

An object of the present invention is to provide a disk drive in which the mechanical resonance frequency of the actuator is controlled while the heads are being loaded or unloaded, thereby to suppress noise that the actuator may make while being driven.

According to an aspect of the present invention, there is provided a disk drive that includes a system for controlling the actuator by performing a multi-rate control method during loading and unloading operation.

The disk drive comprises: a head which writes and reads data on a disk-shaped recording medium; an actuator which holds the head and moves the head over the disk-shaped recording medium and to and from a position outside the disk-shaped recording medium; a parking ramp member which is provided outside the disk-shaped recording medium and near a circumference thereof and which is configured to park the head; and a controller which controls the actuator while the head is being unloaded, moving from a position over the disk-shaped recording medium to the parking ramp member and while the head is being loaded, moving from the parking ramp member to a position over the disk-shaped recording medium. The controller is configured to detect a velocity of the actuator at predetermined sampling intervals, to perform multi-rate control, calculating a plurality of control values within each sampling period, to obtain a control value from the velocity detected, thereby to change the velocity of the actuator to a target velocity.

### BRIEF DESCRIPTION OF THE SEVERAL VIEWS OF THE DRAWING

FIG. 1 is a block diagram showing the major components of a disk drive, which is an embodiment of this invention;

FIG. 2 is a perspective view of the parking ramp member incorporated in the disk drive of FIG. 1;

FIG. 3 is a plan view for explaining how the heads are loaded and unloaded in the disk drive;

FIG. 4 is a block diagram of the control system provided in the disk drive;

FIGS. 5A and 5B are graphs for explaining the multi-rate control method employed in the disk drive;

FIG. 6 is a graph explaining how the multi-rate controller incorporated in the disk drive operates; and

FIG. 7 is a flowchart explaining how the actuator is controlled in the disk drive.

### DETAILED DESCRIPTION OF THE INVENTION

An embodiment of the present invention will be described, with reference to the accompanying drawings.

(Disk Drive)

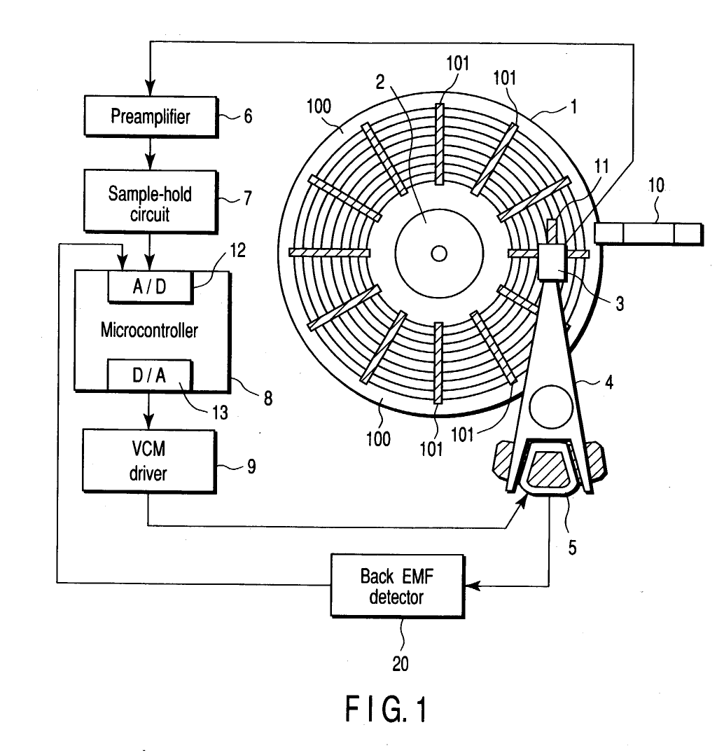

The embodiment of the invention is a disk drive. As FIG. 1 shows, the disk drive has a disk 1, a spindle motor (SPM) 2, a head unit 3, an actuator 4, a voice coil motor (VCM) 5, and a parking ramp member 10. The disk 1 is a recording medium. The head unit 3 is designed to read data from, and write data on, the disk.

The SPM 2 rotates the disk 1. The disk 1 has a number of concentric tracks 100 on one surface. Each track 100 has servo areas 101 spaced at prescribed intervals in the circumferential direction of the disk 1. Servo data is recorded in each servo area 101. The servo system incorporated in the disk drive uses the servo data to move the head unit 3 to a desired position over the disk 1. At the desired position, the head unit 3 can read data from, and write data on, the disk 1.

The head unit 3 is of ordinary type that comprises a slider, a read head, and a write head. Both heads mounted on the slider, spaced apart from each other. The actuator 4 holds the head unit 3. When driven by the VCM 5, the actuator 4 moves the head unit 3 in a radial direction of the disk 1.

To unload the head unit 3, the actuator 4 retracts the head 3 from a position over the disk 1 and parks the head 3 outside the disk 1. More precisely, the tip 11 of the suspension 4 contacts the parking ramp member 10 and slides on the parking ramp member 10 until the suspension 4 stops at a prescribed position outside the disk 1.

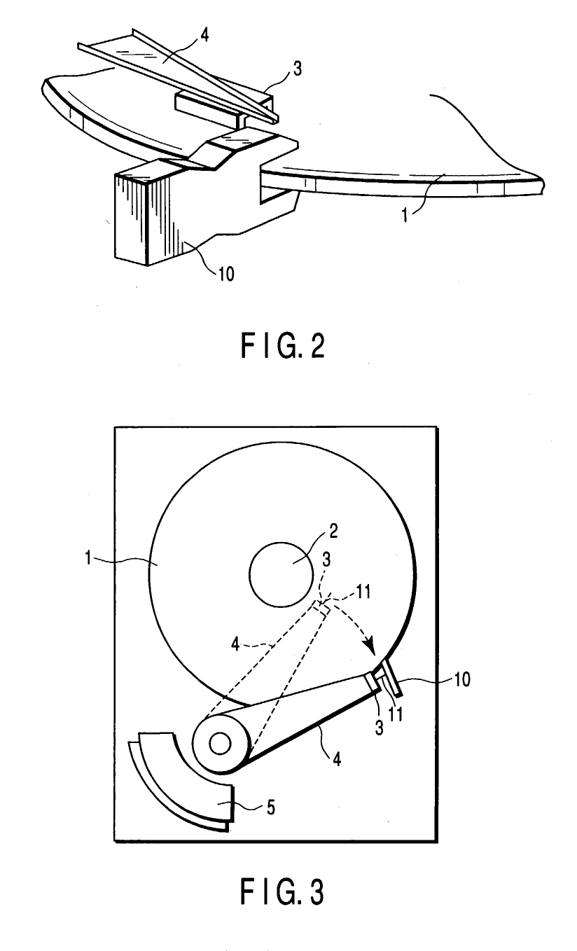

The parking ramp member 10 is provided to park the head 3 outside the disk 1. The member 10 is located outside the disk 1. It can hold the tip 11 of the actuator 4 to park the head 3 as is illustrated in FIG. 2.

To load the head 3, the actuator 4 moves toward the innermost track on the disk 1, with its tip 11 sliding on the parking ramp member 10. As the actuator 4 moves so, the head 3 is positioned above the disk 1 as is illustrated in FIG. 3.

The disk drive further comprises a control system. The control system has a micro-controller 8 (hereinafter referred to as “CPU”) as main component. The control system controls the actuator 4 to load and unload the head 3 and to moves the head 3 to a desired position over the disk 1. Thus, the control system functions as a head-positioning system and a loading/unloading mechanism.

As FIG. 1 shows, the control system comprises a preamplifier 6, a read/write channel (not shown) having a sample-hold circuit 7, a CPU 8, a VCM driver 9, and a back EMF detector 20.

The preamplifier 6 receives a signal the read head of the head unit 3 has read from the disk 1. The signal is either servo data or user data. The amplifier 6 amplifies the signal, which is transferred to the read/write channel. The read/write channel is a circuit that processes read signals and write signals. In the read/write channel, the sample-hold circuit 7 extracts a servo burst signal from the servo data. The read/write channel includes a circuit that reproduces recorded data from the user data.

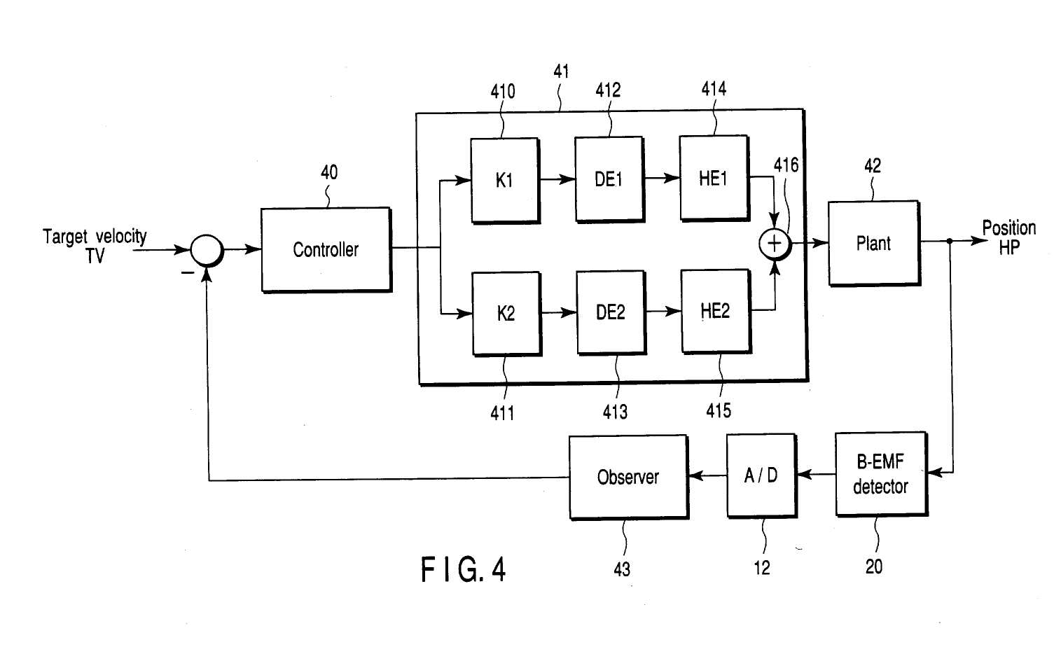

The CPU 8 functions as main controller for controlling the loading/unloading of the head unit 3 and the positioning of the head unit 3, as can be seen from FIG. 4. The CPU 8 includes an A/D converter 12. The A/D converter 12 converts servo burst signals and the back EMF of the VCM 5 to digital data items. The CPU 8 has a D/A converter 13, too. The D/A converter 13 converts the control value obtained to control the position of the head unit 3 or control the velocity of the actuator 4, into an analog value (control voltage).

The VCM driver 9 generates a drive current that corresponds to the control value supplied from the CPU 8. The drive current is supplied to the VCM 5. To control the velocity of the actuator during the loading or unloading of the head unit 3, the CPU 8 receives the value of the back EFM of the VCM 5 from the back EMF detector 20 via the A/D converter 12. From this value the CPU 8 calculates the target velocity at which the actuator 4 (thus, the head unit 3) should be moved.

(Control System)

The velocity of the actuator 4 (head unit 3) is controlled during the loading or unloading of the unit 3 in the disk drive, by means of such a control system as is shown in FIG. 4. This control system is a sampled data controls system that performs a multi-rate control method.

The control system has a main controller 40, a multi-rate controller 41, a plant 42, and an observer 43. The plant 42 is equivalent to the VCM 5 and VCM driver 9 which are to be controlled. When the plant 42 is controlled, the velocity of the actuator 4 is controlled to adjust the position (HP) of the head unit 30.

The main controller 40, multi-rate controller 41 and observer 43 are components that are implemented by the CPU 8 (including software).

The main controller 40 receives the data representing the difference between the target velocity TV for the head unit 3 and the velocity inferred to by the observer 43. From the velocity difference the main controller 40 calculates a control value (current for driving the VCM 5) that will eliminate the velocity difference.

The multi-rate controller 41 is connected to the output of the main controller 40 and performs so-called “multi-rate control.” That is, the controller 41 generates control values at shorter intervals than the observer 43 infers to the velocity of the head unit 3. The control values thus generated are supplied to the plant 42.

More specifically, in the multi-rate controller 41, the control value from the main controller 40 is distributed to two processing sections. An adder unit 416 adds the outputs of the processing sections, generating a control value. The first processing section includes a gain element 410 (gain coefficient K1), a delay element 412 (delay time DE1), and a holder 414 (hold value HE1). The second processing section includes a gain element 411 (gain coefficient K2), a delay element 413 (delay time DE2), and a holder 415 (hold value HE2). The gain element 410 multiplies the control value by a predetermined coefficient, thus changing the gain characteristic of the first processing section. Similarly, the gain element 411 multiplies the control value by another predetermined coefficient, thereby changing the gain characteristic of the second processing section. The delay element 412 changes the phase characteristic of the first processing section, and the delay element 413 (delay time DE2) changes the phase characteristic of the second processing section. The holders 414 and 415 hold two control values MC1 and MC2, respectively. Each of the control values MC1 and MC2 represents the gain and phase characteristics of one processing section, which have been changed by the gain element and delay element of the processing section. Both holders 414 and 415 hold the control values MC1 and MC2, respectively, at intervals that are synchronous with the sampling intervals of the observer 43. The time the holder 414 starts holding the value MC1 is determined by the delay time DE1. The time the holder 415 starts holding the value MC2 is determined by the delay time DE2.

The adder unit 416 adds the values held in the holders 414 and 415. The adder unit 416 outputs the sum of the values, or multi-rate control value MC. The multi-rate control value MC is composed of two parts, each having been output during one sampling period of the observer 43.

(Loading and Unloading)

It will be described how the head unit 3 is loaded and unloaded and how the velocity of the actuator 4 is controlled, in the disk drive according to this embodiment.

When the disk drive finishes reading data from or writing data on the disk 1, or when its power switch is turned off, the head unit 3 is unloaded. To be more specific, the actuator 4 is driven, moving the head unit 3 over the disk 1 and parking the head unit 3 at the ramp member 10 as shown in FIG. 3. To read data from or write data on the disk 1, the head unit 3 is loaded, or moved from the parking ramp member 10 to a position above the disk 1.

While the head unit 2 is being loaded and unloaded, the CPU 8 controls the velocity of the actuator 4, using not the head positioning system but the control system shown in FIG. 4.

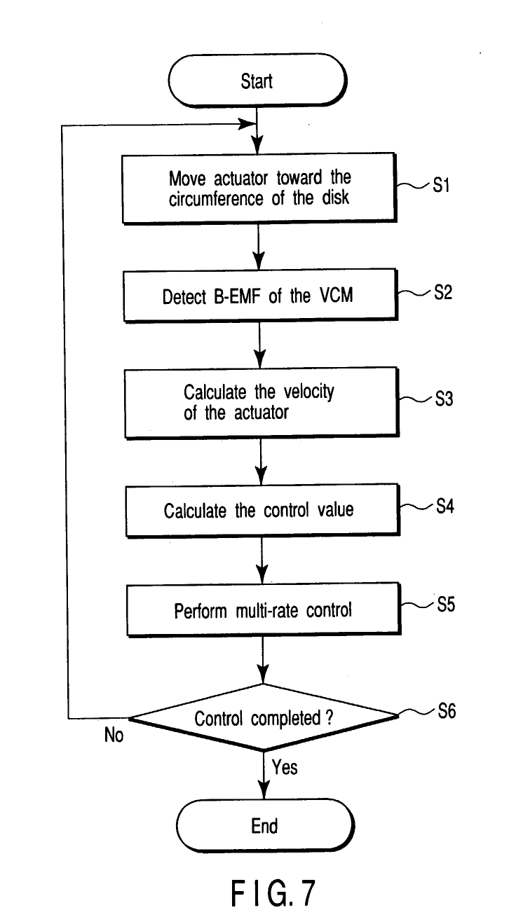

How the CPU 8 controls the actuator 4 during the loading of the head unit 3 will be explained, with reference to FIG. 7. The CPU 8 can, of course, control the actuator 4 during the unloading of the unit 3, in the same manner.

The CPU 8 causes the VCM driver 9 to supply an initial drive current to the VCM 5. Driven with this current, the VCM 5 rotates the actuator 4, thus moving the head unit 3 toward the circumference of the disk 1 (Step S1). The back EMF detector 20 detects the back EMF emanating from the VCM 5 (Step S2).

As FIG. 4 shows, the back EMF observer 43 (i.e., CPU 8) receives the output value of the back EMF detector 20 via the A/D converter 12 and samples the output value at observation intervals. The observer 43 calculates the velocity of the actuator 4 at the observation intervals, too (Step S3). Generally, the back EMF of a voice coil motor and the velocity of an actuator are proportional to each other. So are the back EFM of the VCM 5 and the velocity of the actuator 4. Hence, the velocity of the actuator 4 can be inferred from the back EFM; it need not be measured.

The main controller 40 finds a control value that will be used to move the actuator at the target velocity TV (Step S4). As indicated above, the multi-rate controller 41 receives the control value from the main controller 40. The controller 41 calculates a multi-rate control value MC from the control value (Step 5S). The multi-rate control value MC is composed of two parts, both having been output during one sampling period of the observer 43.

Thus, the VCM 5 is driven and controlled by the multi-rate control value MC that changes at every observation sampling. Thus driven and controlled, the VCM 5 moves the actuator 4 toward the circumference of the disk 1 at the target velocity TV until its tip 11 reaches the parking ramp member 10. When a stopper (not shown) stops the VCM 5, the CPU 8 finishes the multi-rate control.

When the tip 11 of the actuator 4 reaches the parking ramp member 10 and is held by the member 10 to unload the head unit 3, the head unit 3 is retracted from any position over the disk 1. While the head unit 3 is being loaded, the actuator 4 is rotated such that its tip 11 moves toward the center of the disk 1.

(Advantages of the Embodiment)

As indicated above, the actuator 4 undergoes mechanical resonance as its tip 11 contacts the ramp member 10 while the head unit 3 is being loaded or unloaded. Consequently, the actuator 4 makes noise. It has been confirmed that such a noise is made when the resonance frequency is about 5 KHz or 6 KHz. Generally, the sampling frequency must be two or more times the resonance frequency in order for the velocity control system, which is a digital control system, to suppress the mechanical resonance of an actuator.

In the present invention, a control system is used, which performs the multi-rate control in which two control values are output during each sampling period of the observer 43. More precisely, this control system is the multi-rate controller 41. The controller 41 can suppress the resonance of the actuator 4, particularly the resonance of a frequency that is higher than Nyquist frequency.

How the multi-rate control suppresses the mechanical resonance of the actuator 4 will be explained below.

Assume that, the gain coefficients K1 and K2 are 0.5, the delay time DE1 of the delay element 412 is 0 μs and the delay time DE2 of the delay element 413 is 90 μs, in the multi-rate controller 41 shown in FIG. 4.

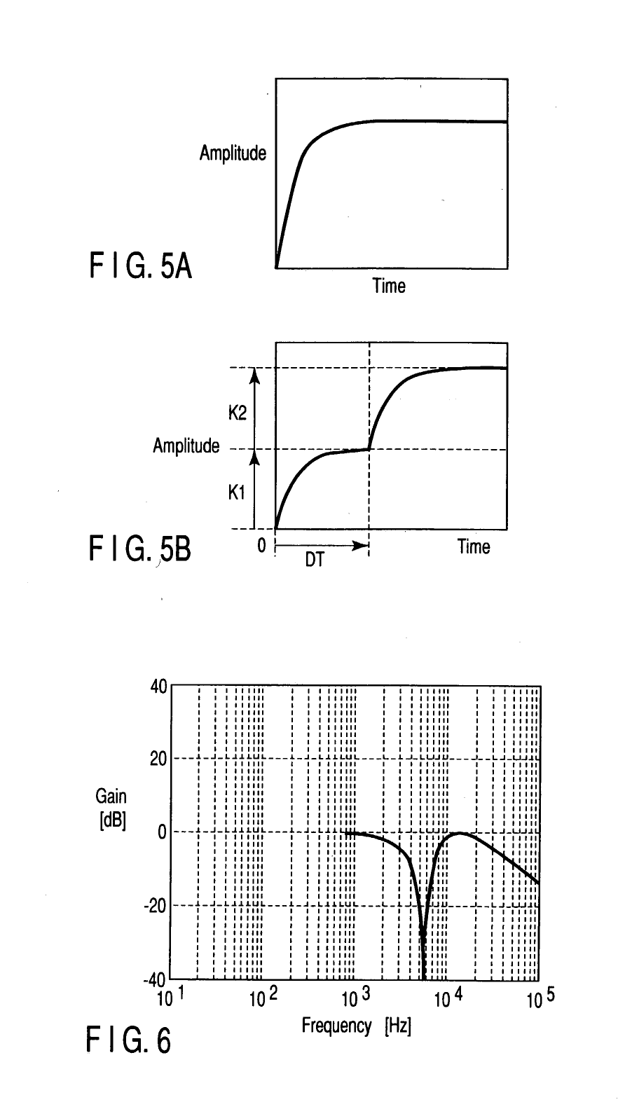

In a control system, wherein one control value is output at each sampling, the drive current output from the VCM driver 9 has the waveform illustrated in FIG. 5A. As seen from the waveform of FIG. 5A, the drive current increases gradually and smoothly because the VCM driver 9 incorporates an analog low-pass filter. In the multi-rate controller 41, the dive current output from the VCM driver 9 has the waveform shown in FIG. 5B. As FIG. 5B depicts, this current waveform has two leading edges for one sampling period.

The current waveform shown in FIG. 5B indicates that two control values are output during each sampling period. The amplitude of the first control value is determined by the gain coefficient K1, and the amplitude of the second control value by the gain coefficient K2. The difference between the first and second control values in terms of rising time is determined by the difference between the delay time DE1 and the delay time DE2.

The multi-rate controller 41 can control a particular frequency component by setting the gain coefficients K1 and K2, the delay time DE1 and the delay time DE2 at specific values (0.5, 0 μs and 90 μs, respectively). In other words, the frequency characteristic of the output control value can provide gain characteristic of FIG. 6, whereby the gain of, for example, 5.5 KHz-component is reduced. This gain characteristic cancels the gain of the 5.5 KHz mechanical resonance of the actuator 4. Thus, the multi-rate controller 41 carries out multi-rate control that suppresses the noise generated from the mechanical resonance of the actuator 4. The resonance characteristic of the actuator 4 can be measured in the course of manufacturing the disk drive.

In summary, the control system according to this embodiment can effectively controls the noise that the actuator 4 makes due to its mechanical resonance during the loading or unloading of the head unit 3. This is because the control system performs multi-rate control, repeatedly calculating control values at the sampling intervals of the observer 43. The multi-rate control suppress the noise the actuator 4 makes, even if the actuator has a resonance frequency higher than Nyquist frequency (which is determined by the sampling intervals of the observer 43). Note that the Nyquist frequency is the highest frequency the control system can control.

Thus, the multi-rate control can provide a velocity-controlling output with a gain characteristic that cancels the frequency component higher than Nyquist frequency. The control system can therefore suppress the noise that the actuator 4 makes due to its mechanical resonance during the loading or unloading of the head unit 3.

The resonance characteristic of the actuator 4 can be determined during the manufacture of the disk drive. Hence, the gain corresponding to a specified frequency component of the mechanical resonance characteristic of the actuator 4 can be controlled by adjusting the operating values set in the components of the multi-rate controller 41. As a result, the control system can suppress the noise generated from the mechanical resonance of the actuator 4.

What is claimed is:

1. A disk drive comprising:
a head which writes and reads data on a disk-shaped recording medium;
an actuator which holds the head and moves the head over the disk-shaped recording medium and to and from a position outside the disk-shaped recording medium;
a parking ramp member which is provided outside the disk-shaped recording medium and near a circumference thereof and which is configured to park the head; and
a controller which controls the actuator while the head is being unloaded, moving from a position over the disk-shaped recording medium to the parking ramp member and while the head is being loaded, moving from the parking ramp member to a position over the disk-shaped recording medium,
the controller configured to detect a velocity of the actuator at predetermined sampling intervals, to perform multi-rate control, calculating a plurality of control values within each sampling period, to obtain a control value from the velocity detected, thereby to change the velocity of the actuator to a target velocity.

2. A disk drive according to claim 1, wherein the actuator includes a voice coil motor, a detector is provided to detect a back electromotive force of the voice coil motor, and the controller calculates the velocity of the actuator from the back electromotive force detected by the detector and performs the multi-rate control to control a drive current of the voice coil motor.

3. A disk drive according to claim 1, wherein the controller has a multi-rate controller which receives, as one input, the control value calculated from the velocity detected of the actuator, and the multi-rate controller performs the multi-rate control to calculate a plurality of control values within each sampling period.

4. A disk drive according to claim 3, wherein the multi-rate controller has two processing means, each configured to adjust a gain and phase of the input, independently of the other processing means.

5. A disk drive according to claim 1, wherein the controller performs the multi-rate control in order to suppress mechanical resonance of the actuator.

6. A disk drive according to claim 1, wherein the controller performs the multi-rate control in order to suppress noise made due to a mechanical resonance characteristic of the actuator.

7. A disk drive according to claim 1, wherein the controller performs the multi-rate control to suppress a mechanical-resonance frequency component which exceeds Nyquist frequency of the actuator.

8. A disk drive comprising:
a head which writes and reads data on a disk-shaped recording medium;
an actuator which holds the head and moves the head over the disk-shaped recording medium and to and from a position outside the disk-shaped recording medium;
a parking ramp member which is provided outside the disk-shaped recording medium and near a circumference thereof and which is configured to park the head;
a head-positioning system which controls the actuator while the head is reading and writing data, to move the head to a target position over the disk-shaped recording medium; and
a control system which perform multi-rate control on the actuator to unload the head by moving the head from a position over the disk-shaped recording medium to the parking ramp member and to load the head by moving the from the parking ramp member to a position over the disk-shaped recording medium.

9. A method of driving a head in a disk drive comprising having a head which writes and reads data on a disk-shaped recording medium, an actuator which holds and moves the head, and a parking ramp member which is provided outside the disk-shaped recording medium and near a circumference thereof and which is configured to park the head, said method comprising:
controlling the actuator while the head is reading and writing data, to move the head to a target position over the disk-shaped recording medium;
performing multi-rate control on the actuator to unload the head by moving the head from a position over the disk-shaped recording medium to the parking ramp member; and
performing multi-rate control on the actuator to load the head by moving the from the parking ramp member to a position over the disk-shaped recording medium.

10. A method according to claim 9, wherein the velocity of the head is detected at predetermined sampling intervals while the head is being loaded and unloaded, the multi-rate control is performed to calculate a plurality of control values within each sampling period, and the head is controlled to move at a target velocity, in accordance with the control values thus calculated.

11. A method according to claim 9, wherein the actuator is configured to move the head by using a drive force of a voice coil motor, and the velocity of the actuator is calculated from a back electromotive force of the voice coil motor, while the head is being loaded and unloaded.

12. A method according to claim 10, wherein the actuator is configured to move the head by using a drive force of a voice coil motor, and the voice coil motor is controlled in accordance with the control values to move the head at a target velocity while the head is loaded and unloaded.

13. A method according to claim 10, wherein the multi-rate control is performed by two processing means, each configured to adjust a gain and phase of a control value calculated from the velocity detected of the head, thereby to calculate a plurality of control values.

14. A method according to claim 9, wherein the multi-rate control is performed to suppress mechanical resonance of the actuator.

15. A method according to claim 9, wherein the multi-rate control is performed to suppress noise made due to a mechanical resonance characteristic of the actuator.

16. A method according to claim 9, wherein the multi-rate control is performed to suppress a mechanical-resonance frequency component which exceeds Nyquist frequency of the actuator.
